(19) United States
(12) Patent Application Publication
(10) Pub. No.: US 2022/0374792 A1
(43) Pub. Date: Nov. 24, 2022

(54) SETUCY

(71) Applicants: Setondji Virgile Nahum, Shoreline, WA (US); Chuanxuan Qiu, Shoreline, WA (US)

(72) Inventors: Setondji Virgile NAHUM, Shoreline, WA (US); Chuanxuan Qiu, Shoreline, WA (US)

(73) Assignee: SETUCY LLC., Seattle, WA (US)

(21) Appl. No.: 17/328,924

(22) Filed: May 24, 2021

(51) Int. Cl. G06Q 10/06; G06Q 30/06; G06Q 30/02; G06Q 30/00

(52) U.S. Cl. CPC G06Q 10/067; G06Q 30/0621; G06Q 30/0201; G06Q 30/018; G06Q 10/06315

(57) ABSTRACT

SETUCY is an innovative business process/method that uses customers' inputs as the continuous defining elements of the scope of the entity's business operations. The customer is the party that specify products and services as opposed to the business offering a limited range of products and services from which the customer must make a selection. Upon a completion of the needs definition stage, SETUCY does validate the customers' needs to ensure feasibility before proceeding to completing any operations, logistics and tasks required to produce the customers deliverables.

The customer inputs a fully-defined need: the customer specifies/select a product and the customer specifies/selects a service. SETUCY validates such defined need. SETUCY proposes and outputs a tailored solution/selection to such defined need. SETUCY handles all logistics required from need definition to product delivery and such includes contacting any manufacturer or relevant 3rd party. SETUCY verifies product/service and product/service quality. SETUCY delivers products/service. Customers confirm receipt of delivered product/service and provide any relevant feedback.

Setucy Products=P(x). x defined by customers specific products/inputs [symbol] ×ε Domain D=[0 ∞].

P(x) is defined as the function that transforms customers' inputs/requests into Setucy products. Domain D represents our observation of no restriction to a specific product.

$$Setucy Services is = S ( x ) . S ( x ) defined by \\ customers ’ inputs / requests \to S ( x ) = {lim}_{x \to ∞} P ( x )$$

S(x) represents SETUCY's continuously evolving services scope.

SETUCY is an innovative business model/method that uses customers' inputs as the continuous defining elements of the scope of the entity/business operations. It is to be supported by a native app built to support the SETUCY Business Process. The APP will be one of the premier interface tools/technologies between SETUCY L.L.C. and its customers. The customer inputs a fully defined need: —The customer specifies/select a product; —The customer specifies/selects a service. SETUCY validates such defined need. SETUCY proposes and outputs a tailored solution/selection to such defined need. SETUCY handles all logistics required from need definition to product delivery and such includes contacting any manufacturer or relevant 3rd party. SETUCY verifies products/services and products/services' quality. SETUCY delivers products/service. Customer validates receipt of delivered product/service.

### Mathematical Definition

From a mathematical perspective, the SETUCY business model/method can be described as follow: —SETUCY Products=P(x). x defined by customers specific products/inputs==>x is element of Domain D=[0 ∞]. P(x) is defined as the function that transforms customers' inputs/requests into SETUCY's products. Domain D represents our observation of no restriction to a specific product. SETUCY' Services is=S(x). S(x) defined by customers' inputs/requests==>S(x)=the limit as x goes to infinity of P(x). S(x) represents SETUCY's continuously evolving services' scope.

### DESCRIPTION OF FIGURES

FIG. 1: The drawing sheet labelled “Drawings” depict FIG. 1.

FIG. 1 is an isosceles and equilateral triangle with its base at the top and its isosceles angle at the bottom. The triangle is filled with a solid blue color that appears as gray/grey on the black and white themed sheet. The arrows around the triangle indicates a specific business process flow where customers define or specify their input, product and services to SETUCY L.L.C. which completes all required operations and tasks to provide or supply the deliverables.

FIG. 2: The drawing sheet labelled “Drawings” depict FIG. 2.

FIG. 2 is an isosceles and equilateral triangle with its base at the bottom and its isosceles angle at the top. The triangle is filled with a solid blue color that appears as grey on the black and white themed sheet. It is the inverse of FIG. 1 and is driven by business input data and customers' needs definitions gathered from the business process depicted by FIG. 2. The arrows around the triangle in FIG. 2 indicates a specific business process flow where SETUCY completes all required operations and tasks required to produce and or supply the customer deliverables. This includes specifying inputs to any relevant third-party entity, business and/or supplier to complete the business operation and output the customer defined deliverables. The business process depicted by FIG. 2 is a sub-part of the business process depicted by FIG. 1.

FIG. 3: Basic SETUCY Business Process Diagram: The drawing sheet labelled “Drawings2” depict FIG. 3: a basic process flow description of the SETUCY business process. It is composed of 6 dialog boxes interconnected by arrows which indicate the flow of operations and activities. The dialog boxes are respectively filled with solid colors green, blue and pink which appear gray/grey on the black and white themed sheet. Similarly, the arrows are respectively filled with solid colors green and blue which appears gray/grey on the black and white themed sheet. The diagram indicates a business process flow where customers specified their needs/inputs, products, and services to SETUCY. SETUCY Validate such inputs and completes all required operations, logistics and quality tasks required to acquire and supply the requested deliverables. After such, SETUCY verifies the deliverables to be outputted to the customer to ensure compliance with customer specifications and any relevant quality requirements, product standards and legal requirements. Finally, SETUCY completes or handle the delivery of the customers requested items and the latter is to confirmed delivery and provide any relevant feedback.

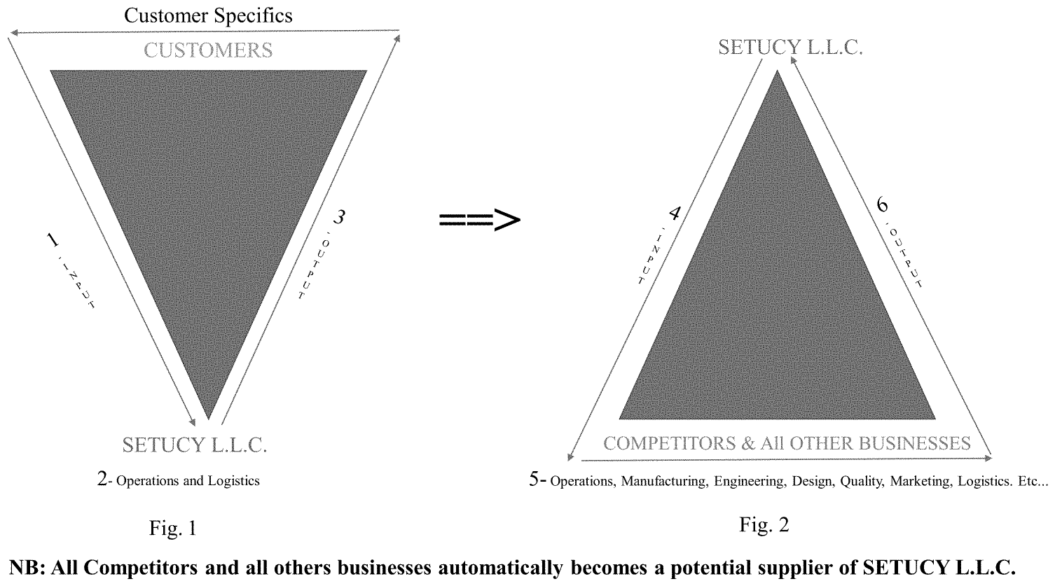

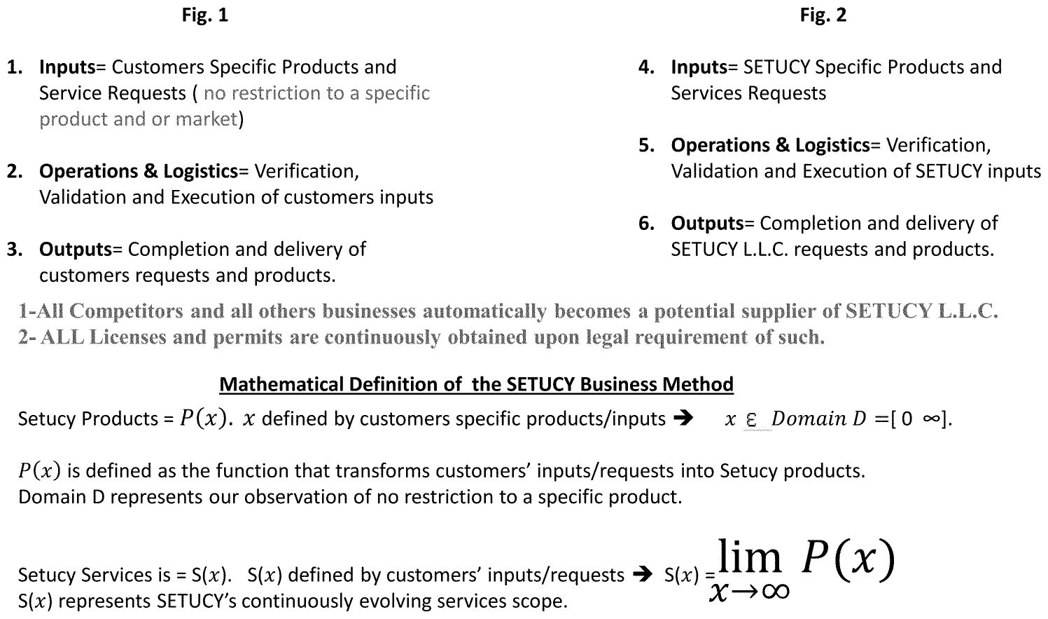

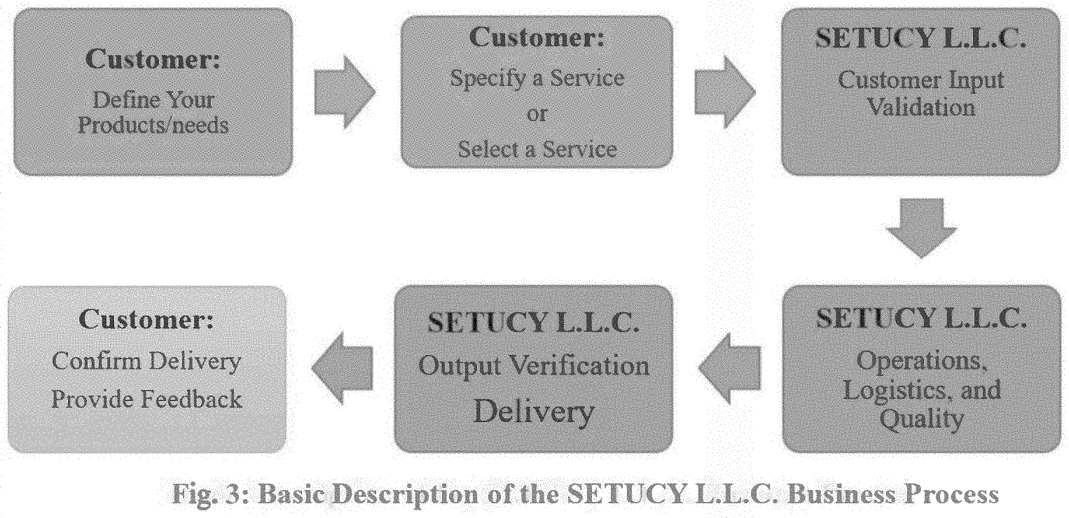

### NOTE

The SETUCY model aims to observe no restriction to a specific product, service, and market. Products are defined/requested by the customer and such regardless of geographical location. Services are selected/requested by the customer and such regardless of geographical location. Therefore, customers ‘inputs continuously define the scope of our company. Our model indicates that all competitors and existing businesses automatically become a potential supplier of SETUCY L.L.C.

1. SETUCY is a business method/model that uses global customer's input as the continuous defining element for the scope of its business. The customer inputs a defined need which may include a product(s) and/or a service(s). SETUCY validate such input, propose and output a tailored solution to the customer's defined need. SETUCY handles all operational deliverables and logistics from customer's need definition to products/services delivery. This includes any 3^{rd} party outsourcing and logistics required for the products/services to be provided or delivered to the customer. SETUCY observe no restriction to a specific product, service and or market.
SETUCY's Products are represented by P(x). x is defined by customers specific products/inputs implies that x is element of Domain D represented by [0 ∞]. P(x) is defined as the function that transforms customers' inputs/requests into SETUCY's products. Domain D represents our observation of no restriction to a specific product. SETUCY' Services is represented by S(x). S(x) defined by customers' inputs/requests implies that S(x) is equal to the limit as x goes to infinity of P(x). S(x) represents SETUCY's continuously evolving services' scope.
The customer inputs a fully defined need which may be a product and or a service. SETUCY validates such defined need. SETUCY proposes and outputs a tailored solution to such defined need. SETUCY handles all logistics required from need definition to product delivery and such includes contacting any manufacturer or relevant 3rd party. SETUCY verifies product/service and product/service quality. SETUCY delivers products/service. Customer validates receipt of delivered product/service.
The SETUCY business model/method shall be supported by technological tools which include interactive needs definition apps, interactive products and services databases, and logistics apps and software to allow SETUCY, the customer and any 3^{rd} party supplier to track the real-time progress of products and services order and/or delivery.
